(19) United States
(12) Patent Application Publication
(10) Pub. No.: US 2025/0015314 A1
(43) Pub. Date: Jan. 9, 2025

(54) MODULE FOR AN ELECTROCHEMICAL DEVICE, HAVING A LONGER USEFUL LIFE

(71) Applicant: COMMISSARIAT A L'ENERGIE ATOMIQUE ET AUX ENERGIES ALTERNATIVES, Paris (FR)

(72) Inventors: Stéphane DI IORIO, Grenoble Cedex 09 (FR); André CHATROUX, Grenoble Cedex 09 (FR); Julie MOUGIN, Grenoble Cedex 09 (FR); Géraldine PALCOUX, Grenoble Cedex 09 (FR); Magali REYTIER, Grenoble Cedex 09 (FR)

(73) Assignee: COMMISSARIAT A L'ENERGIE ATOMIQUE ET AUX ENERGIES ALTERNATIVES, Paris (FR)

(21) Appl. No.: 18/697,931

(22) PCT Filed: Oct. 6, 2022
(86) PCT No.: PCT/FR2022/051886

§ 371 Date: Apr. 2, 2024

(30) Foreign Application Priority Data
Oct. 11, 2021 (FR) 2110725

(51) Int. Cl. H01M 8/0208; C25B 9/77; C25B 13/05; C25B 15/02; H01M 8/0228; H01M 8/0247; H01M 8/04223; H01M 8/12; H01M 8/2425; H01M 8/2457

(52) U.S. Cl. CPC H01M 8/0208; C25B 9/77; C25B 13/05; C25B 15/02; H01M 8/0228; H01M 8/0247; H01M 8/04246; H01M 8/2425; H01M 8/2457; H01M 2008/1293

(57) ABSTRACT

An interconnector for an electrochemical module includes a stack of electrochemical cells and interconnectors, each cell being disposed between two interconnectors and in electrical and mechanical contact with the interconnectors, and electrical insulating elements between two interconnectors and surrounding a cell. The interconnector includes at least one intermediate plate received between two end plates defining gas supply and gas collection chambers therebetween. The intermediate plate includes a central region delimited externally by a lateral region having n lateral branch regions, n being at least equal to 1, each lateral extension being configured to be movable towards and to come into contact with a lateral extension of an intermediate plate of a directly adjacent interconnector in the stack, so as to provide electrical conduction between the two interconnectors, the intermediate plate not being covered by at least one of the two end plates at a lateral branch region.

### TECHNICAL FIELD AND PRIOR ART

The present invention relates to a module for an electrochemical device having a longer useful life.

The electrochemical device may be implemented for high-temperature electrolysis and include a stack of solid-oxide electrolyser cells (SOEC) or as a fuel cell and include a stack of solid-oxide fuel cells (SOFC).

Such a device includes a module or stack comprising a stack of electrochemical cells clamped between two clamping plates. The cells are electrically connected in series.

Each electrochemical cell includes an electrolyte between two electrodes. Interconnection plates are interposed between the cells and ensure electrical connection between the cells. Furthermore, the interconnection plates ensure the gas supply of the cells and the collection of the gases produced at each cell. The document EP3183379 describes an example of an interconnection plate or connector ensuring the electrical connection and the distribution of the gases within the cells. The interconnector includes three plates with a small thickness, one of the plates known as the intermediate plate arranged between the other two plates, known as end plates, enables the distribution of the gases within the O₂ and H₂ chambers.

One of the end plates forms a frame delimiting an aperture on the intermediate plate and receiving a cell which is then in contact with the intermediate plate. The electric current flows from the bottom to the top or from the top to the bottom through the cells and the areas of the interconnectors, which are vertically aligned with the cells.

In operation, the anode and the cathode are the site of electrochemical reactions, whereas the electrolyte enables the transport of ions from the cathode to the anode, or vice versa, depending on whether the electrochemical device is operating in an electrolyser mode or in a fuel cell mode.

Thus, in the electrolyser mode, the cathode compartment enables a supply of steam and a discharge of the water-reduction products, in particular hydrogen, whereas the anode compartment ensures, via a draining gas, the discharge of the dioxygen produced from the oxidation of the O²⁻ ions migrating from the cathode to the anode.

The electrolysis mechanism (“SOEC” mode) of the steam by an elementary electrochemical cell is described hereinbelow. During this electrolysis, the elementary electrochemical cell is supplied by a current flowing from the cathode to the anode. The steam distributed by the cathode compartment is then reduced under the effect of the current according to the following half-reaction:

2H₂O+4e⁻→2H₂+2O²⁻.

The dihydrogen produced during this reaction is then discharged, whereas the O²⁻ ions produced during this reduction migrate from the cathode to the anode, via the electrolyte, where they are oxidised into dioxygen according to the half-reaction:

2O²⁻→O₂+4e⁻.

In turn, the dioxygen thus formed is discharged by the draining gas circulating in the anode compartment.

The electrolysis of the steam corresponds to the following reaction:

2H₂O→2H₂+O₂.

In the fuel cell mode (“SOFC”), air is injected into the cathode compartment which dissociates into O²⁻ ions. The latter migrate towards the anode and react with dihydrogen circulating in the anode compartment to form water. Alternatively, the fuel cell is supplied with CH₄ and air.

Operating in the fuel cell mode enables the production of an electric current.

These systems can operate at temperatures between 600° C. and 1,000° C.

The clamping plates exert a clamping force on the stack in order to ensure good electrical contact between the interconnection plates and the cells and sealing of the stack.

The thermal control of a stack of cells and interconnectors is complex.

Indeed for example in SOEC, depending on the operating point used, which is characterised by a total current and a voltage at the terminals of each of the cells, an endothermic or exothermic reaction takes place. For a cell, for a voltage at its terminals less than 1.3 V, the cell consumes heat during electrochemical reactions and, for a voltage at its terminals greater than 1.3 V, the cell produces heat. This thermal control is complex because the production or the consumption of heat will lead to thermal gradients within the stack. These gradients generate thermomechanical stresses that may lead to the destruction of the object. In addition, a significant temperature rise may damage the seals between the interconnectors, in particular when same are made of glass or glass-ceramic.

If a cell is defective for example due to poor electrical contacts or a degradation of the cell, the voltage at its terminals increases, which generates heat.

The heating phenomenon also appears in a fuel cell of which one of the cells at least is defective.

Yet, due to the complexity of its sealing and to the fragile character of a stack, for example when it includes ceramic parts sealed by glass or glass-ceramic, it is not possible to remove a stack to replace a defective cell. Consequently, for a stack consisting of many cells, the entire stack must be stopped even if a single cell is not operating correctly.

In addition, it should also be noted that in the event of problems for distributing reducing gas on a cell, same may re-oxidise and become insulating. In this case, no operation is possible for the complete stack since an insulating stage exists.

These risks are even greater when the number of cells in a stack is high.

### DISCLOSURE OF THE INVENTION

Consequently, one aim of the present invention is to propose a module for an electrochemical device having a longer useful life by having means for limiting the heating sources and/or for bypassing an insulating cell.

The abovementioned aim is achieved by an interconnector for an electrochemical module including a stack of electrochemical cells and interconnectors interposed between the cells, the interconnector including means for making it possible to short-circuit one or more electrochemical cells when the voltage at its terminals or at their terminals is too high and/or when the cell(s) is(are) insulating.

Thus, when a cell is the site of too much heating due to a degradation of same or its electrical contacts and/or when a cell has become insulating particularly due to re-oxidisation, the cell may be electrically insulating. A cell is no longer operating but the module can continue to operate and the risk of destruction of the stack due particularly to overheating is eliminated. The module then has a longer life in relation to the modules of the prior art which are discarded as the defective cell(s) cannot be replaced.

Thus, the object of the invention, according to one of its aspects, is an interconnector for an electrochemical module that includes a stack of electrochemical cells and interconnectors, each cell being disposed between two interconnectors and in electrical and mechanical contact with said interconnectors, and electrical insulating elements, each electrical insulating element being interposed between two interconnectors and surrounding a cell, wherein the interconnector includes at least one intermediate plate received between two end plates defining gas supply and gas collection chambers therebetween, wherein the intermediate plate includes a central region delimited externally by a lateral region including n lateral branch regions, n being at least equal to 1, each lateral branch region being configured to be movable towards a lateral branch region of an intermediate plate of a directly adjacent interconnector in the stack, and to come into contact with same so as to provide electrical conduction between the two interconnectors, the intermediate plate not being covered by at least one of the two end plates at a lateral branch region.

In other terms, the module integrates means for selectively short-circuiting a cell within the stack.

The interconnector according to the invention may further include one or more of the following features taken alone or according to any possible technical combinations.

According to a first aspect, all or part of the n lateral branch regions may be in the form of n exposed regions of the intermediate plate, not superimposed on at least one of the two end plates, particularly n exposed regions located at one or more angles of the intermediate plate. They may particularly be obtained by cutting at least one of the two end plates.

According to a second aspect, all or part of the n lateral branch regions may be in the form of n lateral extensions protruding externally in relation to the lateral region of the intermediate plate, the n lateral extensions particularly extending laterally beyond the edges of the end plates. Thus, the interconnector may include one or more lugs, or also tabs, projecting from the lateral region, same may be connected with the lug(s) of the interconnector located directly above or below in the stack in order to short-circuit the cell located between the two interconnectors.

The short-circuiting means are configured to have an impedance less than that of the interconnector and cell assembly to be short-circuited.

Highly advantageously, the lateral branch regions may be distributed over the outer contour of each interconnector about the axis of the stack, which makes it possible to limit the disturbances applied to the operation of the cells upstream and downstream of the short-circuited cell.

The lateral branch regions may be integral with the intermediate plate.

Furthermore, the lateral branch regions may be covered by an electrically conductive material and protecting against corrosion, for example a cobalt-manganese or cobalt-cerium alloy.

Moreover, another object of the invention, according to another of its aspects, is a module for an electrochemical device including a stack of electrochemical cells and interconnectors such as defined above, each cell being disposed between two interconnectors and in electrical and mechanical contact with said interconnectors, and electrical insulating elements, said lateral branch regions of two directly adjacent interconnectors being at least partly facing.

The electrical insulating elements may be made of mica.

Advantageously, an electrically conductive element may be added between said lateral branch regions of two directly adjacent interconnectors, particularly a gold gate and/or a gold paste.

In addition, the ratio between the branch surface formed by the lateral branch regions of two interconnectors and the active surface of the cell located between the two interconnectors may be between 1/100 and ½ and is preferably equal to 1/10.

Each electrical insulating element may cover the lateral branch regions.

Furthermore, each electrical insulating element may include pre-cuts to facilitate the removal of the portion of the electrical insulating element in line with the lateral branch regions.

In addition, the electrical insulating element may also provide the sealing between two interconnectors.

Moreover, another object of the invention, according to another of its aspects, is a solid-oxide electrolyser including a module such as defined above, a gas supply of the cells, a collection of the gases produced by each cell and a power supply configured to supply in series the cells.

Another object of the invention, according to another of its aspects, is a solid-oxide fuel cell including a module such as defined above, a dihydrogen (H₂) and dioxygen (O₂) or methane (CH₄) and air supply of the cells, a collection of the gases produced by each cell and means for collecting the electric current produced by each electrochemical cell.

Moreover, another object of the invention, according to another of its aspects, is a method for short-circuiting a cell such as defined above, including:
placing in contact, possibly by deformation, n lateral branch regions of the interconnectors disposed directly on either side of said cell, so as to move the lateral branch regions towards one another,
joining the lateral branch regions together in order to form n electrically conductive paths between the two interconnectors. Joining together may be obtained by spot welding.

In addition, the method may include a step of removing by abrasion an oxide layer on each of the lateral branch regions prior to joining them together.

### BRIEF DESCRIPTION OF THE DRAWINGS

The present invention will be better understood based on the following description and the appended drawings wherein:

FIG. 1 is a schematic representation of an example of a module of an electrochemical device according to the invention in a state where all of the cells are passed through by an electric current,

FIG. 2 shows the module of FIG. 1 in a state wherein a cell is short-circuited,

FIG. 3 is a perspective view of an example of interconnector according to the invention,

FIG. 4 is an exploded view of the interconnector of FIG. 3,

FIG. 5 is a detail view of another example of embodiment of a module according to the invention,

FIG. 6 is a partial perspective view of another example of interconnector according to the invention,

FIG. 7 is a graphic representation of the voltage variation within each cell of a module varying the current passing through the module, including two defective cells and connected in series with the other cells of the module, and

FIG. 8 is a graphic representation of the voltage variation within each cell of the module of FIG. 7 by imposing the current passing through the module, wherein the two defective cells have been electrically short-circuited thanks to the present invention.

### DETAILED DISCLOSURE OF PARTICULAR EMBODIMENTS

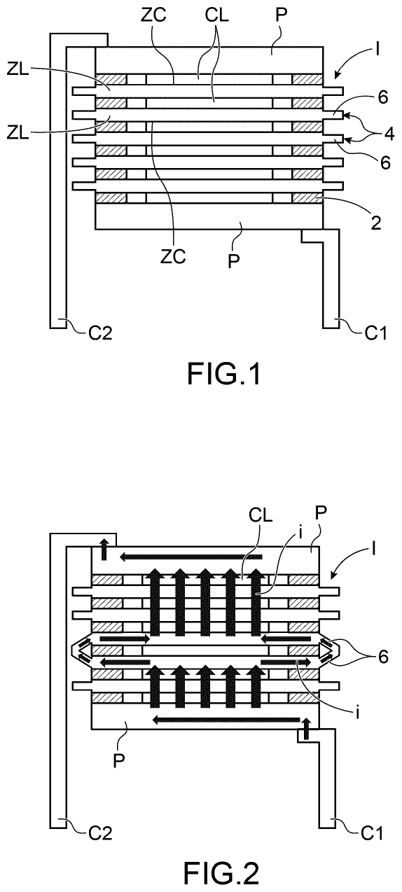

In FIGS. 1 and 2, a schematic representation can be seen of one example of embodiment of a module for an electrochemical device according to the invention.

The electrochemical device to which the module may belong may be intended to be implemented for high-temperature electrolysis (“SOEC” mode) or as a fuel cell (“SOFC” mode).

The module includes a stack of electrochemical cells or solid-oxide cells. The elementary electrochemical cells CL are each formed of a cathode, of an anode and of an electrolyte disposed between the anode and the cathode. The electrolyte is a solid and dense ion conductor, and the anode and the cathode are porous layers.

The module further includes interconnectors I, each interposed between two successive cells and ensuring the electrical connection between an anode of a cell and a cathode of the adjacent cell. The interconnectors I ensure a connection in series of the elementary cells.

A module may include between one cell and several hundreds of cells, preferably between 25 cells and 100 cells.

The interconnectors also delimit fluid compartments at the surface of the electrodes with which they are in contact.

The face of an interconnector I in contact with an anode of an elementary electrochemical cell CL delimits a compartment, known as anode compartment, and the face of an interconnector I in contact with a cathode of an elementary electrochemical cell CL delimits a compartment, known as cathode compartment.

Each of the anode and cathode compartments makes it possible to distribute and collect said gases.

For example, for the electrolysis of water, the cathode compartment ensures a steam supply of the cathode and the discharge of the hydrogen produced. The anode compartment ensures the circulation of a draining gas and the discharge of the oxygen produced at the anode.

The module may include terminal plates P disposed on either side of the module. The terminal plates are electrically conductive.

The device also includes tubes (not shown) for distributing the gases and tubes for collecting the gases.

In general, the electrochemical device also comprises a clamping system (not shown) provided with two clamping plates, disposed on either side of the module in the direction of the stack and intended to exert a clamping force on the stack via tie rods.

One and/or other of the two clamping plates is or are provided with at least one gas circulation pipe that makes it possible to circulate gas from a gas inlet to a gas outlet in order to supply gases to or discharge gases from the solid-oxide stack.

The gas inlet and outlet are disposed, respectively, on one and the other of the faces with the largest surface of the clamping plate.

Each interconnector I has a substantially flat shape and includes a central region ZC and a lateral region ZL surrounding the central region ZC.

The interconnectors have a larger surface than that of the cells and each cell is in contact by one face with a central region ZC of an interconnector and by another face with a central region ZC of the other interconnector.

Electrical insulating elements 2 are interposed between the interconnectors, more particularly between the lateral regions ZL of two interconnectors in contact with the same cell. The electrical insulating elements 2 form a frame surrounding the cell. The electrical insulating means are for example made of mica, vermiculite, thermiculite or any other material having good thermal insulation properties at high temperature.

For example and preferably, the electrical insulating elements 2 associated with a glass-ceramic also ensure the sealing. An example of such an element is described in the document EP1362100, same comprises a support means for example mica, surrounding the cell and in contact with the lateral regions of the interconnectors and a means for ensuring the sealing, for example made of glass or glass-ceramic. The support means includes a channel passing therethrough on either side so as to connect its two faces in contact with the interconnectors. During the manufacturing of the module a sufficient pressure and heating are applied to cause the melting of the glass that flows into the channel and comes into contact with the two interconnectors ensuring the sealing.

Moreover, means for electrically connecting the stack are provided so as to supply in series the cells in the case of an electrolyser, or to collect the electric current produced in the case of a fuel cell. In FIG. 1, the electrical connection means include a current rod C1 connected to the lower terminal plate and a current rod C2 connected to the upper terminal plate. Preferably, the current flows from bottom to top.

Each interconnector I includes short-circuiting means 4. The means for short-circuiting 4 an interconnector I in contact with a face of a cell, cooperate with the means for short-circuiting 4 the interconnector I in contact with the other face of the cell, making it possible to short-circuit this cell and therefore limit, in the case of an electrolyser, the current flowing through same, thus reducing the voltage at its terminals and the generation of heat.

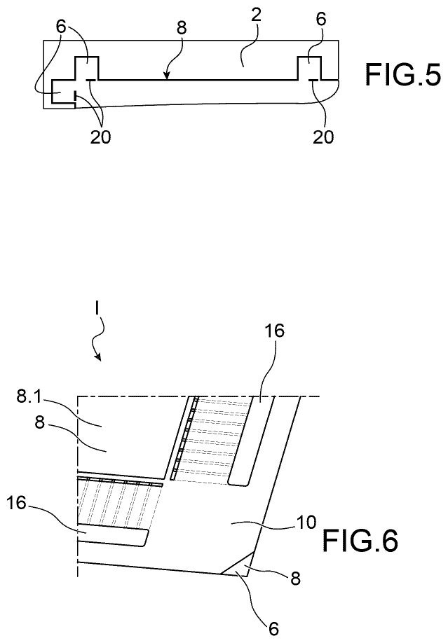

In accordance with the invention, the short-circuiting means 4 include one or more lateral branch regions 6 of the interconnector I, in the form of lateral extensions 6 in the example of FIGS. 1 to 5 and in the form of exposed regions 6 in the example of FIG. 6.

The intermediate plate 8 is not advantageously covered by the end plates 10, 12 at these lateral branch regions 6.

The lateral branch regions 6 in the form of lateral extensions as in the example of FIGS. 1 to 5 extend from the outer edge of the interconnector I, so that in the stack this or these extension(s) protrude(s) from the general outer lateral surface of the stack.

In the example of FIG. 6, the lateral branch regions 6 are in the form of exposed regions 6 that are obtained by one or more modifications of the end plates 10, 12 so as not to cover the intermediate plate 8 in places, in particular at the angles or corners of the intermediate plate 8 as can be seen in FIG. 6. The end plates 10, 12 are thus shortened at these angles.

In other words, the lateral branch regions 6 are obtained by shortening one at least of the end plates 10, 12 and/or by extending the intermediate plate 8 beyond its lateral region ZL.

The lateral branch regions 6 are such that they may possibly be deformed, particularly in the case of lateral extensions 6, in order to be placed in contact with the lateral branch regions 6 of the interconnector I located directly below or above in the stack.

In the stack, each lateral branch region 6 of an interconnector | is located at least partly in line with a lateral branch region 6 of each interconnector I and advantageously completely in line with a lateral branch region 6 of each interconnector I. Thus, each lateral branch region 6 by simple deformation normal to the mid-plane of the interconnector I, particularly, may be placed in contact with a lateral branch region 6 of an interconnector I located directly above or below. The mid-plane of the interconnector I is the plane wherein the interconnector I extends and wherein it has its largest dimensions.

When the lateral branch region(s) 6 of two interconnectors I located on either side of a cell are placed in contact and preferably assembled by tacking such as shown in FIG. 2, the cell is electrically short-circuited and the current preferably flows via the lateral branch regions 6. A very low current also flows in the cell. Tacking enables effective assembly while limiting the risks of deterioration of the elements surrounding the lateral branch regions 6. Alternatively, the connection is performed by welding by adding material, nevertheless particular precautions should be taken so as not to deteriorate the rest of the stack. It is also possible to add a highly conductive element between the two lateral branch regions 6 to favour the contact, particularly in the case of exposed extensions as in FIG. 6, for example a gold gate, a gold paste or any other highly conductive element.

Preferably, the short-circuiting means include a plurality of lateral extensions forming lugs distributed around the entire outer edge of the interconnector. When a cell is short-circuited the distribution of the current flowing directly between the two interconnectors is then more homogeneous, which is favourable to the operation of cells located upstream and downstream of the short-circuited cell. Upstream and downstream are considered in relation to the direction of flow of the electric current in the stack. Furthermore, the heating is reduced and offset in an unused region of the stack, that is to say outside of the central regions ZC. Heating on the lateral extensions is of no consequence for the electrolyser.

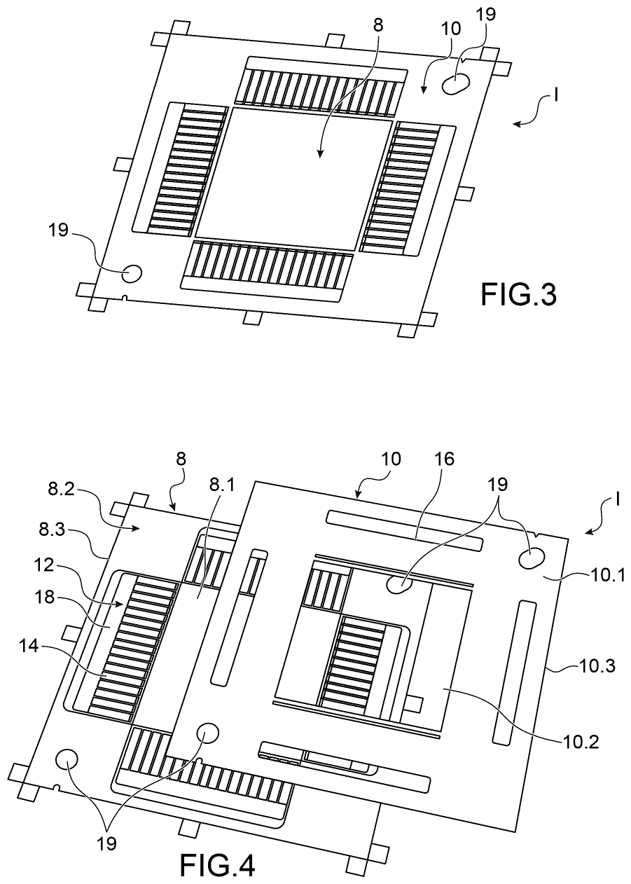

In FIGS. 3 and 4, it is possible to see a first example of embodiment of an interconnector according to the invention, and in FIG. 6, it is possible to see a second example of embodiment of an interconnector according to the invention. FIGS. 3 and 4 are described here but identical references in FIG. 6 designate identical or similar elements.

Therefore, the interconnector I includes an intermediate plate 8 and two end plates 10, 12 between which the intermediate plate 8 is received. An example of such an interconnector structure without short-circuiting means is described in the document EP3183379.

The three plates delimit between them supply chambers. For example, in the case of an electrolyser, the intermediate plate 8 enables the gas supply to the chamber with O₂ of the plate 10 and to the chamber with H₂ of the plate 12.

The intermediate plate 8 includes a central portion 8.1, intended to be in contact with a face of a cell, and a lateral portion 8.2 surrounding the central portion 8.1 including holes 14. In this example, the lateral portion 8.2 includes four groups of holes each distributed along an outer edge 8.3 of the intermediate plate 8. The holes have a slot shape perpendicular to one edge and are connected by a hole parallel to the edge.

The first end plate 10 includes a central portion 10.1 hollowed out so as to surround the cell, and a lateral portion 10.2 surrounding the central portion. The lateral portion 10.2 includes four holes 16 each extending parallel to an outer edge 10.3 of the first end plate. Each hole is formed by an elongated slot.

The second end plate 12 including a central portion and a lateral portion. The lateral portion includes four holes 18 each extending parallel to an outer edge of the second end plate. Each hole is formed by an elongated slot.

Here and within the scope of the invention, “hole” means a hole opening on either side of a plate.

The three plates 8, 10, 12 also include guide holes 19, for example round and/or oblong in shape, making it possible to pass the guide rods through. These rods make it possible at various stages to be guided during the clamping, the holding force being submitted at the top of the stack and transmitted over the entire surface.

The intermediate plate 8 and the two end plates 10, 12 have the same surfaces or substantially the same surfaces and when the three plates are superimposed, the outer edges of the three plates are aligned with one another along the vertical direction so as to define four lateral faces of the stack, forming the lateral surface of the stack. It will be understood that other plate shapes may be considered, for example polygonal, or even circular or ellipsoidal shapes.

The plates are preferably metal sheets, advantageously made of ferritic steel. The thicknesses of the plates are typically between 0.1 mm and 1 mm, advantageously equal to 0.2 mm. Furthermore, the intermediate plate 8 includes the lateral extensions 6 in the example of FIGS. 3 and 4. However, it concerns exposed lateral regions 6 in the example of FIG. 6.

When the cells and the interconnectors are stacked, the lateral extensions 6 of the interconnectors I protrude from the lateral surface of the stack so as to be accessible.

In this example, three extensions are provided on each edge 8.3 of the plate. The extensions are disposed on the four outer edges. As the angles are easier to access, an extension is provided on each side of each angle as in the example shown. The number of lateral extensions is not limiting, it is chosen depending on the surface of each extension so that the assembly represents a sufficiently large surface so that the electrical conductivity of the branch surface formed by the assembly of lateral extensions is greater than the electrical conductivity of the cell to be short-circuited. In this example the lateral extensions have a rectangular shape, which makes it possible to offer a significant contact surface between the lateral extensions that favours thermal conductivity. Other shapes are possible, for example a triangular or partly circular shape.

Advantageously for an active surface of 100 cm², i.e. which corresponds to the surface of the cell and of the central region 8.1 of the intermediate plate, the total branch surface in the plane formed by all of the lateral extensions is between 1 cm² and 50 cm², preferably equal to 10 cm².

Advantageously, the ratio between the branch surface and the active surface is between 1/100 and ½ and is preferably equal to 1/10.

The number of lateral extensions is advantageously between 4 and 24 and preferably equal to 12 as in FIGS. 3 and 4.

With such an embodiment, the voltage of a defective cell may be substantially reduced to a value between 0 V and 0.5 V, preferably equal to 0.1 V.

In an advantageous example of embodiment, at least the lateral extensions are covered with a layer that protects against corrosion, for example a layer of a cobalt-manganese or cobalt-cerium alloy. Thus, during the connection of the lateral extensions of two interconnectors the electrical conductivity is not reduced by an electrically insulating oxide layer. Alternatively, during the production of connections a step of removing the oxide layer possibly formed on the lateral extensions is provided, in particular on the faces intended to be in contact. This removal is for example performed by abrasion.

In another example of embodiment, each intermediate plate includes a single lateral extension that is formed by an extension of the lateral edge of the intermediate plate. This example has the advantage of offering a large branch surface nevertheless the connection with the intermediate plate of the other interconnector may be complex.

Preferably, the lateral extensions are integral with the intermediate plate, which reduces the electrical resistance and simplifies the manufacturing. The lateral extensions may be produced by simultaneously cutting the rest of the intermediate plate. Alternatively, the lateral extensions are secured on the intermediate plate, for example by welding.

Advantageously, the intermediate plate as well as the lateral extensions and the end plates 10, 12 are made of ferritic steel of the Crofer 22 or K41 type. In an advantageous example of embodiment shown in FIG. 5, the electrical insulating element 2 has dimensions in the plane so as to cover the lateral extensions 6 and thus ensure the electrical insulation also between two superimposed lateral extensions 6 so long as the cell between the two interconnectors operates normally.

When a connection between two interconnectors is desired for short-circuiting the cell disposed between these two interconnectors, the portions of the element 2 covering the lateral extensions are removed making it possible to place in contact the facing lateral extensions.

Highly advantageously, the portions of the electrical insulating element 2 in line with the lateral extensions 6 are delimited by pre-cuts 20 facilitating their removal by easy breakage if necessary.

One example of a method for short-circuiting a cell will now be described.

When a faulty cell within the stack is detected, this detection being for example obtained by the voltage measurements of each cell that are carried out to monitor the change in the life state of the stack, it is decided to electrically insulate same from the rest of the stack so that it does not degrade the operation of the device.

The lateral extensions 6 of the intermediate plates located on either side of the faulty cell are moved towards one another in an off-plane direction, i.e. each lateral extension 6 is deformed towards the lateral extension 6 facing the other intermediate plate. Subsequently, they are joined together preferably by tack welding. It should be noted that the thickness of the lateral extensions is in the order of a few tens of mm, therefore same may be easily deformed. Furthermore, the distance between two facing lateral extensions is in the order of the thickness of a cell and of its contact layers, in the order of 1 mm. Consequently, the deformation required for placing in contact the lateral extensions is low.

All of the lateral extensions of the two intermediate plates are then connected forming a branch surface the electrical conductivity of which is greater than that of the faulty cell. The current i then flows directly from one intermediate plate to the other as shown schematically in FIG. 2, the voltage in the faulty cell drops and it no longer generates heat.

In order to illustrate the effectiveness of the present invention, the voltage at the terminals of each cell of a stack was measured depending on the current applied in the case of a stack of 25 cells and of 100 cm² of active surface, the stack operating in electrolysis. The gas flow sent is 6 Nml/min/cell/cm² of a mixture of steam (90%) and of H₂ (10%).

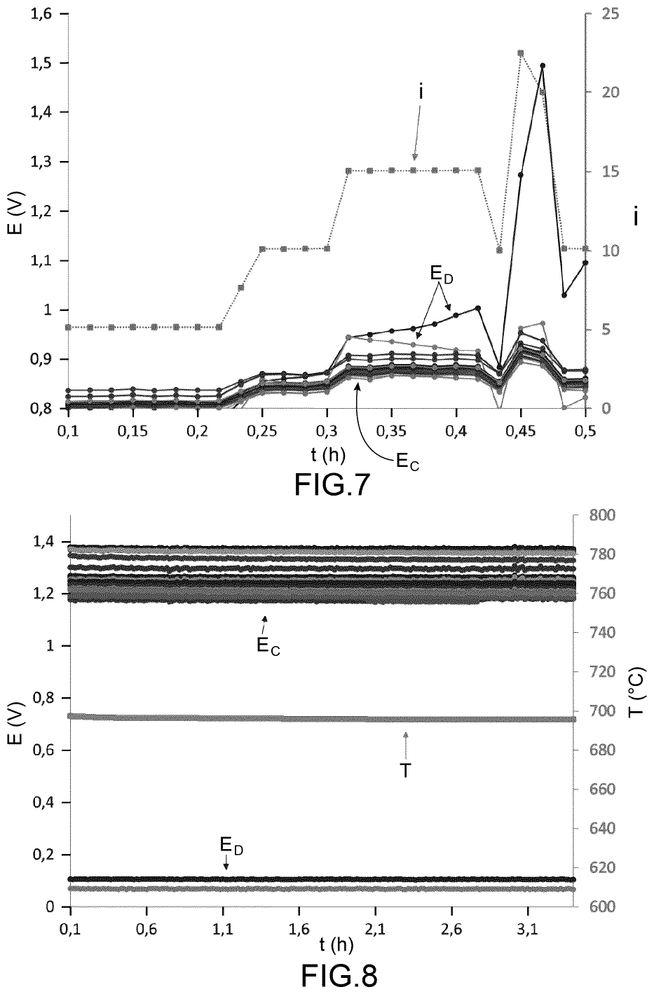

In FIG. 7, it is possible to see the change in voltages in V over time in h for currents i in A progressively increased. The maximum acceptable current is 15 A since for greater currents the voltages of two cells exceed 1.4 V. These two cells are faulty. Above this voltage, they will generate heat.

In FIG. 8, it is possible to see the change in voltages for an imposed current at 50 A for the same stack and in the same conditions, but the faulty cells have been insulated. It is noted that the two faulty cells have voltages in the order of 0.1 V and the other cells operate correctly without their voltage exceeding 1.4 V and hydrogen is produced. Furthermore, a good stability of the voltages of the cells with branching is observed. In addition, the temperature of the stack was also measured, same is stable which demonstrates the effectiveness of the invention.

Thanks to the invention, it is relatively easy to insulate one or more faulty cells in order to protect the operation of a module and extend its useful life.

1-15. (canceled)

16. An interconnector for an electrochemical module, comprising:
a stack of electrochemical cells and interconnectors, each cell of the electrochemical cells being disposed between two of the interconnectors and in electrical and mechanical contact with the interconnectors; and
electrical insulating elements, each of the electrical insulating elements being interposed between two of the interconnectors and surrounding a cell, wherein
the interconnect includes at least one intermediate plate received between two end plates defining gas supply and gas collection chambers therebetween, and
the intermediate plate includes a central region delimited externally by a lateral region including n lateral branch regions, n being at least equal to 1, each of the lateral branch regions being configured to be movable towards and to come into contact with one of the lateral branch regions of one of the intermediate plates of a directly adjacent interconnector in the stack, so as to provide electrical conduction between the two of the interconnectors, the intermediate plate not being covered by at least one of the two end plates at a lateral branch region.

17. The interconnector according to claim 16, wherein all or part of the n lateral branch regions are in a form of n exposed regions of the intermediate plate, not superimposed on at least one of the two end plates.

18. The interconnector according to claim 17, wherein the n exposed regions of the intermediate plate are located at one or more angles of the intermediate plate.

19. The interconnector according to claim 16, wherein all or part of the n lateral branch regions are in a form of n lateral extensions protruding externally in relation to the lateral region of the intermediate plate.

20. The interconnector according to claim 19, wherein the n lateral extensions extend laterally beyond edges of the end plates.

21. The interconnector according to claim 16, wherein the lateral branch regions are distributed around an outer contour of each interconnector about an axis of the stack.

22. The interconnector according to claim 16, wherein the lateral branch regions are integral with the intermediate plate.

23. The interconnector according to claim 16, wherein the lateral branch regions are covered by an electrically conductive material and protecting against corrosion.

24. The interconnector according to claim 23, wherein the electrically conductive material is one of a cobalt manganese and cobalt-cerium alloy.

25. A module for an electrochemical device including the stack of electrochemical cells and interconnectors according to claim 16, each of the electrochemical cells being disposed between two of the interconnectors and in electrical and mechanical contact with the interconnectors and the electrical insulating elements, the lateral branch regions of two directly adjacent interconnectors being at least partly facing.

26. The module according to claim 25, wherein an electrically conductive element is added between the lateral branch regions of the two directly adjacent interconnectors.

27. The module according to claim 26, wherein the electrically conductive element is at least one of a gold gate and a gold paste.

28. The module according to claim 25, wherein a ratio between a branch surface formed by the lateral branch regions of two of the interconnectors and an active surface of the cell located between the two of the interconnectors is between 1/100 and ½.

29. The module according to claim 28, wherein the ratio is equal to 1/10.

30. The module according to claim 25, wherein each of the electrical insulating elements covers the lateral branch regions.

31. The module according to claim 30, wherein each electrical insulating element includes pre-cuts to facilitate a removal of a portion of the electrical insulating element in line with the lateral branch regions.

32. A solid-oxide electrolyser, comprising:
the module according to claim 25;
a gas supply of the cells;
a gas collection produced for each of the cells; and
a power supply configured to supply in series the cells.

33. A solid-oxide fuel cell, comprising:
the module according to claim 25;
a dihydrogen and dioxygen or methane and air supply of the cells;
a collection of the gases produced by each of the cells; and
means for collecting electric current produced by each of the electrochemical cells.

34. A method for short-circuiting a cell of the module according to claim 25, comprising:
placing in contact, by deformation, the n lateral branch regions of the interconnectors disposed directly on either side of the cell, so as to move the lateral branch regions towards one another; and
joining the lateral branch regions together in order to form n electrically conductive paths between the two of the interconnectors.

35. The method according to claim 34, further comprising removing by abrasion an oxide layer on each of the lateral branch regions prior to joining them together.
